(19) United States
(12) Patent Application Publication
(10) Pub. No.: US 2005/0195152 A1
(43) Pub. Date: Sep. 8, 2005

(54) [BLINKING BACKLIGHT DEVICE AND OPERATION METHOD THEREOF]

(76) Inventors: Chih-Hsiang Yang, Taoyuan County (TW); Huan-Hsin Li, Miaoli County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,509

(22) Filed: May 11, 2004

(30) Foreign Application Priority Data
Mar. 3, 2004 (TW) 93105481

(51) Int. Cl. G09G 3/36

(52) U.S. Cl. 345/102

(57) ABSTRACT

A blinking backlight device and an operation method thereof are provided. The blinking backlight device comprises a light source brightness balance module, a blinking control module and a storage unit. An image detection unit of the blinking control module is used for comparing a recent frame data and a frame data read from the storage unit. When the recent frame data comprises a motion image, the blinking backlight is enabled. When the recent frame data comprises a static image, the blinking backlight is disabled. In addition, the light source brightness balance module is used to control the brightness and the duty cycle of the cold cathode fluorescence lamp according to whether the frame data comprises the motion image or the static image.

### CROSS REFERENCE TO RELATED APPLICATIONS

This application claims the priority benefit of Taiwan application serial no. 93105481, filed Mar. 03, 2004.

### BACKGROUND OF INVENTION

1. Field of the Invention

The present invention generally relates to a backlight device. More particularly, the present invention relates to a blinking backlight device and a method of enabling or disabling the blinking backlight device and thereby adjusting the brightness of the blinking backlight device according to whether the recently displayed image is a still image or a motion image.

2. Description of Related Art

In recent years, since the liquid crystal has properties between crystal and liquid, and the direction of the liquid crystal molecule may be arranged by applying an external electric field. Therefore, the liquid crystal has been broadly applied in display components

The liquid crystal material was first discovered in 1888 by F. Rinitzer, an Australian botanist, who used benzoic acid and acetic acid derivatives, and compounds of cholesterol to demonstrate characteristics of liquid crystal. The application of liquid crystal in the display device was since 1963. However, the liquid crystal was not commercialized for industrial production until the Japan's Sharp company developed a calculator with a liquid crystal display (LCD). Thereafter, a variety of liquid crystal display devices are being rapidly developed by Japanese manufacturers and applied to many other electronic appliances such as digital watch, display panels of car, game player, meter and so on. In recent years, the full-color liquid crystal display device has broadly widened the application field of the liquid crystal. In general, the liquid crystal display device has the advantageous features of being light weight, thin thickness, low driving voltage, small size, low power consumption compared to the traditional display device such as cathode ray tube (CRT). Therefore, the conventional CRT display device has been gradually replaced by the LED display device especially in the field of portable electronic appliances, such as, portable TV, notebook computer, office projector and display devices.

Conventionally, a blinking backlight device is used in the LCD device to enhance the continuity of the frames of the motion picture when the LCD device is used for displaying a motion picture. Thus, when the blinking backlight device is activated, a blinking backlight is also activated simultaneously to maintain the brightness the frame of the picture. However, the average brightness generated by the blinking backlight is lower than that generated by the fixed backlight device. Therefore, when the blinking backlight device is used for displaying a static image, the brightness generated by the blinking backlight device is lower than that of the fixed backlight device, and the frame displayed is blinking.

### SUMMARY OF INVENTION

Therefore, the present invention is directed to a blinking backlight device and an operation method thereof for using an image detection unit to detect whether the frame data displayed recently comprises motion image or static image to decide whether or not to enable the blinking backlight.

According to an embodiment of the present invention, the duty cycle of the fluorescence lamp is controlled and the brightness of the frame is balance depending on whether the image displayed is a motion image or a static image.

A blinking backlight device, according to an embodiment of the invention, is provided for detecting the image displayed by the blinking backlight device. For example but not limited to, when the image displayed comprises a motion image, the blinking backlight is enabled. Alternatively, when the image displayed comprises a static image, the blinking light is disabled. In addition, the blinking backlight device comprises, for example but not limited to, blinking control module and a storage unit.

In one embodiment of the present invention, at least an (N−1)^{th} frame data is stored in the storage unit.

In one embodiment of the present invention, the blinking control module comprises, for example but not limited to, image detection unit for operating the received N^{th} frame data and the (N−1)^{th} frame data read from the storage unit according to the motion image detection algorithm and outputting a detection signal. In one embodiment of the invention, N is a positive integer and is larger than or equal to 2.

In one embodiment of the present invention, the motion image detection algorithm is provided for determining whether the image displayed by the blinking backlight device comprises a motion image or a static image. When the image displayed by the blinking backlight device comprises a motion image, the blinking backlight is enabled by the detection signal. Alternatively, when the image displayed by the blinking backlight device comprises a static image, the blinking backlight is disabled by the detection signal.

In one embodiment of the present invention, the blinking backlight device further comprises a light source brightness balance module. The light source brightness balance module comprises, for example but not limited to, a cycle and brightness control unit for processing the received scan signal and clock signal and outputting a light source duty cycle control signal and brightness control signal.

In one embodiment of the present invention, the cycle and brightness control unit comprises, for example but not limited to, a duty cycle control mechanism and a brightness control mechanism. The duty cycle control mechanism is provided for controlling the duty cycle of the fluorescence lamp when the fluorescence lamp is activated. The brightness control mechanism is provided for controlling the brightness of the fluorescence lamp according to whether the image displayed by the blinking backlight device is static image or motion image.

In one embodiment of the present invention, the backlight control module further comprises data latch for outputting the N^{th} frame data and storing the N^{th} frame data to the storage unit.

In operation method of a blinking backlight device, according to an embodiment of the invention, first, whether an image recently displayed by a blinking backlight device comprises a motion image or not is determined according to two continuously frame data by the image detection unit of the blinking backlight device. When the image displayed comprises motion image, the blinking backlight is enabled. Alternatively, when the image displayed does not comprise motion image, the blinking backlight is disabled.

In one embodiment of the present invention, the operation method further comprises a step of adjusting the brightness of the light source by determining whether the image displayed by the blinking backlight device comprises motion image or not according to the scan signal and the clock signal. When it is determined by the brightness control mechanism that the image displayed by the blinking backlight comprises a motion image, a brightness control signal is outputted to increase the brightness of the light source. Alternatively, when it is determined that the image displayed by the blinking backlight device does not comprise a motion image, a brightness control signal is outputted to decrease the brightness of the light source.

Accordingly, an image detection unit is provided for detecting the image frame, wherein when a recently displayed frame comprises a motion image, the blinking backlight is enabled, and when a recently displayed frame comprises a static image, the blinking backlight is disabled.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 is a circuit diagram illustrating a blinking backlight device according to one embodiment of the present invention.

FIG. 2A is a circuit diagram schematically illustrating a duty cycle control mechanism according to one embodiment of the present invention.

FIG. 2B is a waveform diagram schematically illustrating the input and output waveform of a duty cycle control mechanism according to one embodiment of the present invention.

FIG. 3 is a drawing schematically illustrating a pixel according to one embodiment of the present invention.

FIG. 4 is a flow chart of the operation process of a blinking backlight device according to one embodiment of the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

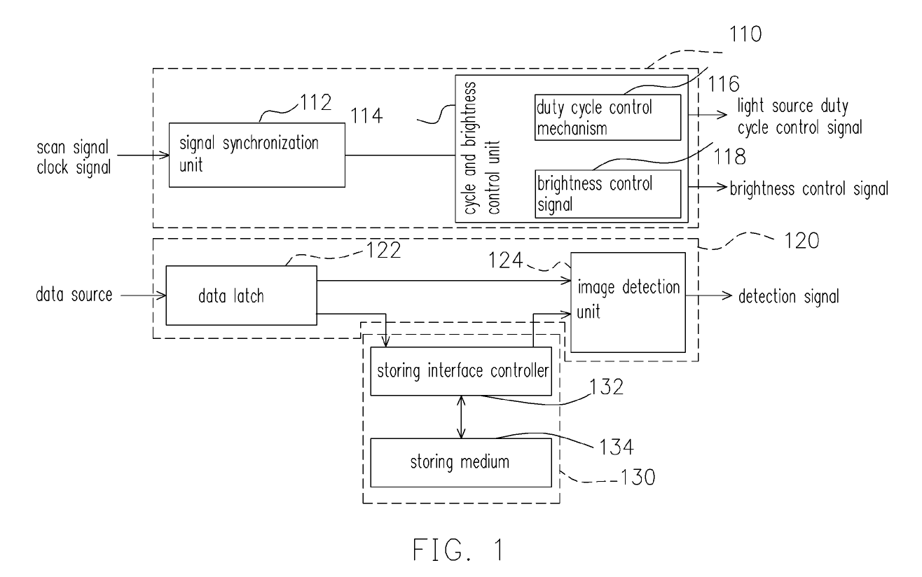

FIG. 1 is a circuit diagram illustrating a blinking backlight device according to one embodiment of the present invention. Referring to FIG. 1, it is noted that, when a motion image is detected, the blinking backlight is enabled, however, when a static image is detected, the blinking backlight is disabled.

In one embodiment of the present invention, the blinking backlight device 100 comprises, for example but not limited to, a light source brightness balance module 110, a blinking control module 120 and a storage unit 130.

In one embodiment of the present invention, the blinking control module 120 comprises a data latch 122 and an image detection unit 124. The data latch 122 is connected to the storage unit 130 and the image detection unit 124 and is adapted for receiving the data from the data source.

The data latch 122 is provided for receiving the frame data from the data source, and copying the frame data to the storage unit 130 for storing and then outputting the frame data. The image detection unit 124 is provided for operating the received N^{th} frame data with the (N−1)^{th} frame data read from the storage unit 130 according to the motion image detection rule, and then a detection signal is outputted. Wherein, N is a positive integer larger than or equal to 2.

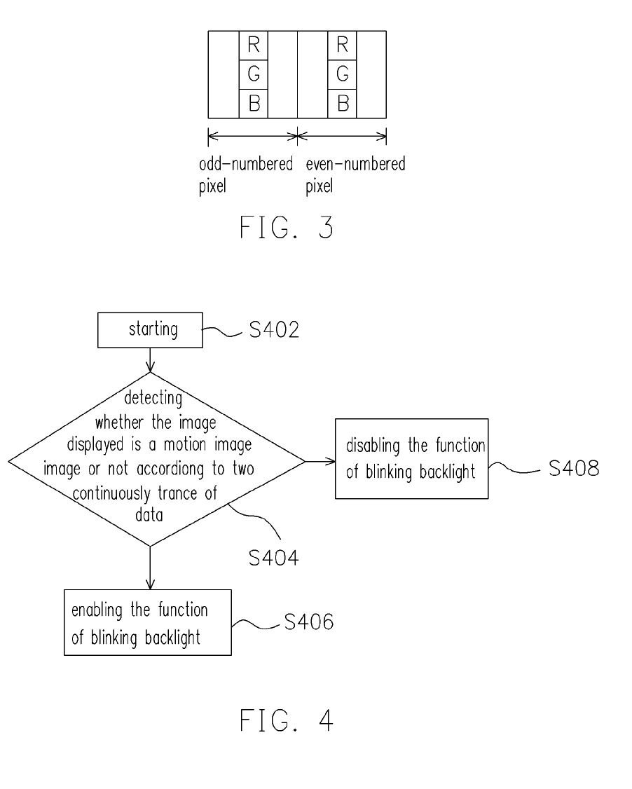

FIG. 3 is a drawing schematically illustrating a pixel according to one embodiment of the present invention. Referring to FIG. 3, the frame data transmitted from the data latch 122 to the image detection unit 124 may be classified into odd pixels and even pixels, wherein each of the odd pixel and the even pixel may also be classified into red R, green G and blue B. In one embodiment of the present invention, a motion image detection algorithm comprising operating the received R, G and B of each of the odd pixel and the even pixel of the frame data with that of the frame data read from the storage unit 130 to obtain a motion detection value. For example, when the operation is provided for R of the even pixel, the formula of operation maybe (RE(N))⊕(RE(N−1)), wherein, ⊕ is an exclusive or (XOR) operation or an exclusive or gate. RE(N) is the R of the even pixel of the N^{th} frame data, and RE(N−1) is the R of the even pixel of the (N−1)^{th} of frame data. When (RE(N))⊕(RE(N−1))=1 (i.e., the motion detection value is 1), it is noted that the RE of the N^{th} frame data of the blinking backlight device 100 is different from the RE of the (N−1)^{th} frame data. On the other hand, when (RE(N))⊕(RE(N−1))=0 (i.e., the motion detection value is 0), it is noted that the RE of the N^{th} frame data of the blinking backlight device 100 is the same as the RE of the (N−1)^{th} frame data. It is noted that, the scope of the invention is not limited to the embodiment described above.

In one embodiment of the present invention, in the blinking backlight device 100, the RE (red even pixel), GE (green even pixel), BE (blue even pixel), RO (red odd pixel), GO (green odd pixel) and BO(blue odd pixel) of the N^{th} frame data are operated with the RE, GE, BE, RO, GO and BO of the (N−1)^{th} frame data respectively. Thereafter, when the sum of the motion detection value is larger than or equal to a predetermined value α(i.e., the image displayed is a motion image), the blinking backlight is enabled.

Referring to FIG. 1, in one embodiment of the present invention, the light source brightness balance module 110 comprises, for example but not limited to, a signal synchronization unit 112 and a cycle and brightness control unit 114. The signal synchronization unit 112 is connected to the cycle and brightness control unit 114 for receiving the scan signal YDIO and the clock signal YCLK. The cycle and brightness control unit 114 is provided for processing the scan signal and the clock signal, and then outputting a light source duty cycle signal and a brightness control signal. The cycle and brightness control unit 114 comprises, for example but not limited to, a duty cycle control mechanism 116 and a brightness control mechanism 118.

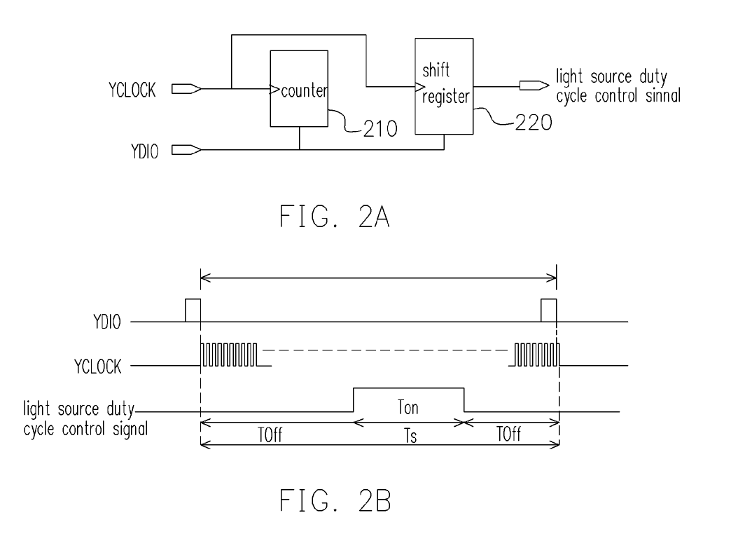

FIG. 2A is a circuit diagram schematically illustrating a duty cycle control mechanism according to one embodiment of the present invention. FIG. 2B is a waveform diagram schematically illustrating the input and output waveform of a duty cycle control mechanism according to one embodiment of the present invention. Referring to FIG. 2A, the duty cycle control mechanism 116 comprises, for example but not limited to, a counter 210 and a shift register 220. The clock signal YCLK is provided to the counter 210 and the shift register 220. The scan signal YDIO is also provided to the counter 210 and the shift register 220. Referring to FIG. 2B, the clock signal YCLK is continuously provided to the counter 210 and the shift register 220. For example, when the N^{th} frame data is provided from the scan signal YDIO, the shift register 220 is operated according to the scan signal. For example, when the scan signal is at logic-high voltage level (i.e., the blinking backlight device 100 is displaying a motion image), a light source duty cycle control signal for controlling the activation of the fluorescence lamp is outputted. The duty cycle is defined as Ton/Ts, wherein the Ton is the time of fluorescence lamp being turned on, Ts is the time between the falling edge of the N^{th} frame data and the falling edge of the (N+1)^{th} frame data, and Toff is the time of the fluorescence lamp being turned off.

In one embodiment of the present invention, the blinking backlight device 100 comprises, for example but not limited to, a plurality of scan lines (not shown). It is noted that, when an image data is written to a pixel, the scan line of the pixel is driven.

In one embodiment of the present invention, the brightness of the fluorescence lamp is decided by the brightness control mechanism 118 according to whether the blinking backlight device 100 is in a static image state or in a motion image state. In another embodiment of the present invention, the brightness control mechanism 118 comprises, for example but not limited to, an inverter for controlling the brightness via the current. However, the scope of the invention is not limited by these embodiments.

Referring to FIG. 1, the storage unit 130 comprises, for example nut not limited to, a storage interface controller 132 and a storage medium 134. The storage medium 134 is provided for storing the frame data copied by the data latch 122. The storage interface controller 132 is connected to the storage medium 134 for storing and reading the frame data stored in the storage medium 134.

FIG. 4 is a flow chart of the operation process of a blinking backlight device according to one embodiment of the present invention. Referring to FIG. 4, after the operation process is started (step s402), the image recently displayed by the blinking backlight device is detected by the image detection unit of the blinking backlight device to decide whether the image displayed is a motion image or not according to two continuously displayed frame data (step s404). When the recently displayed image is a motion image, the blinking backlight is enabled (step s406). Alternatively, when the recently displayed image is not a motion image, the blinking backlight is disabled (step s408).

In one embodiment of the present invention, the operation process further comprises adjusting the brightness of the light source by the brightness control mechanism according to whether the image displayed by the blinking backlight device is a motion image or not by using the scan signal and the clock signal. When the brightness control mechanism detects that the image displayed by the blinking backlight device is a motion image, a brightness control signal is outputted to increase the brightness of the light source. Alternatively, when the image displayed by the blinking backlight device is not a motion image, a brightness control signal is outputted to decrease the brightness of the light source.

In one embodiment of the present invention, the fluorescence lamp comprises, for example but not limited to, a cold cathode fluorescence lamp.

Accordingly, the blinking backlight device and the operation method thereof of the present invention has the following advantages. First, whether the recently displayed image is a motion image or not is detected, and the blinking backlight is enabled or disabled according to the result of the detection. In addition, according to an embodiment of the present invention, the duty cycle of the fluorescence lamp can be controlled to control the brightness. According to an embodiment of the present invention, when a motion image is displayed, the brightness of the frame may be reduced, and when a static image is displayed, the brightness of the frame may be increased. Therefore, the brightness of the frame can be effectively balanced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A blinking backlight device, comprising:
a storage unit, for storing at least one (N−1)^{th} frame data; and
a blinking control module, having an image detection unit, connected to a data source and the storage unit, for receiving a N^{th} frame data and comparing the N^{th} frame data and the(N−1)^{th} frame data read from the storage unit according to a motion image detection algorithm to output a detection signal;
wherein N is a positive integer larger than or equal to 2.

2. The blinking backlight device of claim 1, wherein the motion image detection algorithm detects whether an image displayed by the blinking backlight device is a motion image or not.

3. The blinking backlight device of claim 2, wherein when the image displayed by the blinking backlight device comprises a motion image, a blinking backlight is enabled by the detection signal.

4. The blinking backlight device of claim 2, wherein when the image displayed by the blinking backlight device is not a motion image, a blinking backlight is disabled by the detection signal.

5. The blinking backlight device of claim 1, further comprising:
a light source brightness balance module, having a cycle and brightness control unit, for processing a received scan signal and a clock signal to output a light source duty cycle signal and a brightness control signal.

6. The blinking backlight device of claim 5, wherein the cycle and brightness control unit comprises:
a duty cycle control mechanism, for controlling a duty cycle of a fluorescence lamp when the fluorescence lamp is activated; and
a brightness control mechanism, for controlling a brightness of the fluorescence lamp according to whether the image displayed by the blinking backlight device is the motion image or not.

7. The blinking backlight device of claim 5, wherein the light source brightness balance module further comprises a signal synchronization unit connected to the cycle and brightness control unit for synchronizing the scan signal and the clock signal.

8. The blinking backlight device of claim 5, wherein the fluorescence lamp comprises cold cathode fluorescence lamp (CCFL).

9. The blinking backlight device of claim 1, wherein the light source brightness balance module further comprises a data latch connected to the image detection unit and the storage unit for outputting a frame data received and stored in the storage unit.

10. The blinking backlight device of claim 9, wherein the storage unit comprises:
a storage medium, for storing the frame data; and
a storage interface controller, connected to the storage medium for storing and reading the frame data stored in the storage medium.

11. A method of operating a blinking backlight device, comprising:
determining whether an image displayed comprises a motion image or not according to two continuous frame data;
when the image displayed comprises a motion image, a blinking backlight is enabled; and
when the image displayed does not comprise a motion image, a blinking backlight is disabled.

12. The method of claim 11, further comprising:
adjusting a brightness of a light source.

13. The method of claim 12, wherein a method of determining whether to adjust the brightness of the light source or not comprises determining an image displayed by the blinking backlight device comprises the motion image or not according to a scan signal and a clock signal.

14. The method of claim 13, wherein when the image displayed by the blinking backlight device comprises the motion image, a brightness control signal is outputted to increase the brightness of the light source.

15. The method of claim 13, wherein when the image displayed by the blinking backlight device does not comprise the motion image, a brightness control signal is outputted to decrease the brightness of the light source.
